(19) United States
(12) Patent Application Publication
(10) Pub. No.: US 2011/0123841 A1
(43) Pub. Date: May 26, 2011

(54) ELECTRODE ASSEMBLY AND SECONDARY BATTERY INCLUDING THE SAME

(76) Inventors: Changbum Ahn, Yongin-si (KR); Youngbae Sohn, Yongin-si (KR); Jeongsoon Shin, Yongin-si (KR)

(21) Appl. No.: 12/943,657

(22) Filed: Nov. 10, 2010

(30) Foreign Application Priority Data
Nov. 26, 2009 (KR) 10-2009-0115145

(51) Int. Cl. H01M 2/00; H01M 4/485; H01M 2/16

(52) U.S. Cl. 429/7; 429/231.1; 429/246

(57) ABSTRACT

An electrode assembly and a secondary battery including the same are disclosed. An electrode assembly includes a positive electrode including a positive electrode coating portion coated on a surface of a positive electrode collector; a negative electrode including a negative electrode coating portion coated on a surface of a negative electrode collector; and a separator between the positive and negative electrodes. The positive electrode and the negative electrode are stacked, and the positive electrode coating portion and the negative electrode coating portion on surfaces facing each other have a same area, or an area of the positive electrode coating portion is greater than an area of the negative electrode coating portion within a tolerance range.

### CROSS-REFERENCE TO RELATED APPLICATION

This application claims priority to and the benefit of Korean Patent Application No. 10-2009-0115145, filed on Nov. 26, 2009, the entire content of which is incorporated herein by reference.

### BACKGROUND

1. Field

Aspects of embodiments of the present invention relate to an electrode assembly and a secondary battery including the same.

2. Description of the Related Art

With the rapid advance of electronic, communication and computer industries recently, the supply of portable electronic equipment is increasing. As the power supply source of the portable electronic equipment, a secondary battery capable of recharging is mainly being used.

A typical secondary battery includes an electrode assembly that includes a separator interposed between and insulating a positive electrode and a negative electrode.

### SUMMARY

According to an aspect of embodiments of the present invention, in an electrode assembly and a secondary battery including the same, an area of a positive electrode coating portion is the same as that of a negative electrode coating portion or the area of the positive electrode coating portion is greater than that of the negative electrode coating portion within a tolerance range.

According to another aspect of embodiments of the present invention, in an electrode assembly and a secondary battery including the same, a positive electrode and a negative electrode are easily aligned, thereby reducing or preventing structural unstability and/or chemical unstability due to an alignment error.

According to one embodiment of the present invention, an electrode assembly includes: a positive electrode including a positive electrode coating portion coated on a surface of a positive electrode collector; a negative electrode including a negative electrode coating portion coated on a surface of a negative electrode collector; and a separator between the positive electrode and the negative electrode for insulating the positive electrode, and the positive electrode and the negative electrode are stacked, the surface of the positive electrode and the surface of the negative electrode are facing each other, and the positive electrode coating portion and the negative electrode coating portion on the surfaces facing each other have a same area, or an area of the positive electrode coating portion is greater than an area of the negative electrode coating portion within a first tolerance range.

According to another embodiment of the present invention, a secondary battery includes: an electrode assembly; a pouch accommodating the electrode assembly; and a circuit protection module electrically connected to the electrode assembly, and the electrode assembly includes: a positive electrode including a positive electrode coating portion coated on a surface of a positive electrode collector; a negative electrode including a negative electrode coating portion coated on a surface of a negative electrode collector; and a separator between the positive electrode and the negative electrode for insulating the positive electrode, and the positive electrode and the negative electrode are stacked, the surface of the positive electrode and the surface of the negative electrode are facing each other, and the positive electrode coating portion and the negative electrode coating portion on the surfaces facing each other have a same area, or an area of the positive electrode coating portion is greater than an area of the negative electrode coating portion within a first tolerance range.

The first tolerance range may be about 0.3% of the area of the positive electrode coating portion.

An area of the positive electrode may be the same as an area of the negative electrode, or the area of the positive electrode may be greater than the area of the negative electrode within a second tolerance range.

The second tolerance range may be about 0.3% of the area of the positive electrode.

The separator may include a non-woven fabric.

The separator may include a material selected from the group consisting of polyethylene, polypropylene, polyvinylidene fluoride, polyethylene oxide, polyacrylonitrile, and polyvinylidene fluoride hexafluoropropylene.

The negative electrode coating portion may include lithium titanium oxide (LTO). The positive electrode coating portion may be coated on an entire area of the surface of the positive electrode collector other than a positive electrode tab, and the negative electrode coating portion may be coated on an entire area of the surface of the negative electrode collector other than a negative electrode tab. The positive electrode coating portion may be further coated on another surface of the positive electrode collector that is opposite the surface of the positive electrode collector, and the negative electrode coating portion may be further coated on another surface of the negative electrode collector that is opposite the surface of the negative electrode collector.

The electrode assembly may be a stack type electrode assembly.

### BRIEF DESCRIPTION OF THE DRAWINGS

The above and other features and advantages will become more apparent to those of ordinary skill in the art by describing in detail some exemplary embodiments of the present invention with reference to the attached drawings, in which:

FIG. 1 is a perspective view of an electrode assembly according to an exemplary embodiment of the present invention;

FIG. 2 is an exploded view of the electrode assembly of FIG. 1;

FIG. 3 is an exploded view of a portion of the electrode assembly of FIG. 1;

FIG. 4 is a partially disassembled view of a secondary battery according to another exemplary embodiment of the present invention; and

FIG. 5 is a graph showing that swelling does not highly occur in the secondary battery according to embodiments of the present invention.

### DETAILED DESCRIPTION

Some exemplary embodiments will now be described more fully hereinafter with reference to the accompanying drawings; however, embodiments of the present invention may be embodied in different forms and should not be construed as limited to the exemplary embodiments illustrated and set forth herein. Rather, these exemplary embodiments are provided by way of example for understanding of the invention and to convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” or “over” another layer, it can be directly under or over, respectively, or one or more intervening layers may also be present. In addition, it will also be understood that when a layer is referred to as being “between” two layers, it can be the only layer between the two layers, or one or more intervening layers may also be present. Like reference numerals refer to like elements throughout.

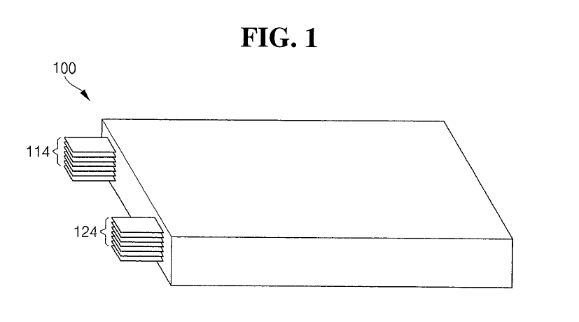

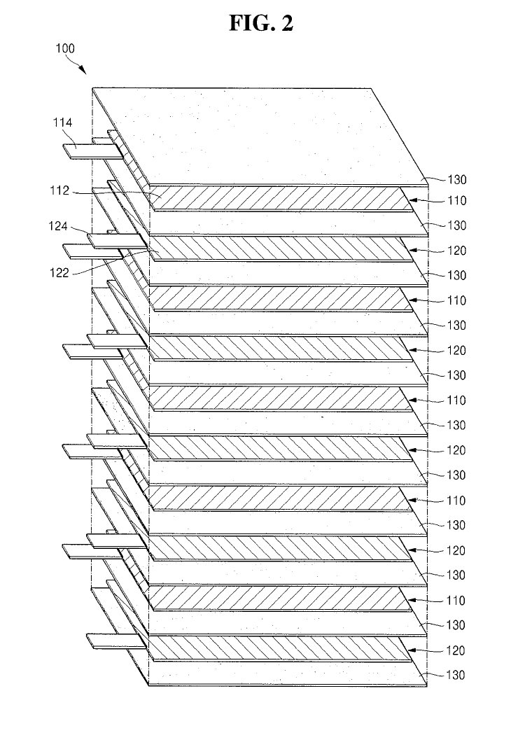

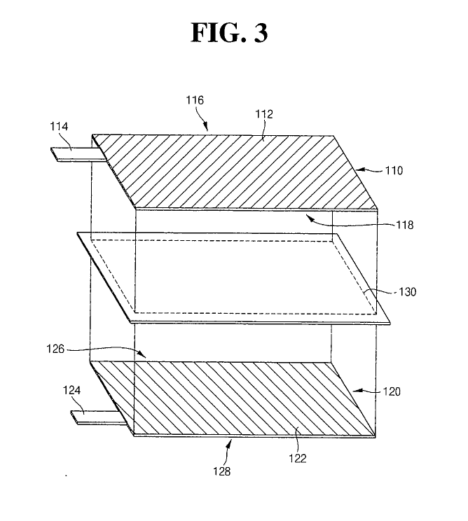

FIG. 1 illustrates an electrode assembly according to an exemplary embodiment of the present invention. FIG. 2 illustrates a disassembled state of the electrode assembly of FIG. 1. FIG. 3 illustrates a disassembled state of a portion of the electrode assembly of FIG. 1.

Referring to FIGS. 1 through 3, an electrode assembly 100 according to an exemplary embodiment of the present invention includes a positive electrode 110, a negative electrode 120, and a separator 130.

In the positive electrode 110, a positive electrode coating portion 112 is coated on at least one of opposite first and second surfaces 116 and 118 of a positive electrode collector. In one embodiment, the positive electrode collector is formed of aluminum or an aluminum alloy. Alternatively, the positive electrode collector may be formed of any other suitable material.

In one embodiment, the positive electrode coating portion 112 includes lithium titanium oxide (LTO). Alternatively, the positive electrode coating portion 112 may be formed of any other suitable material or combination of materials.

In the negative electrode 120, a negative electrode coating portion 122 is coated on at least one of opposite first and second surfaces 126 and 128 of a negative electrode collector. In one embodiment, the negative electrode collector is formed of copper or a copper alloy. Alternatively, the negative electrode collector may be formed of any other suitable material.

In one embodiment, the negative electrode coating portion 122 includes one or more negative electrode active materials in which lithium ion may be intercalated and deintercalated. The negative electrode active materials may include crystal or amorphous carbon or the carbon composites of carbon-based negative electrode active materials. However, the negative electrode active materials are not limited to the above-described materials but, alternatively, may include any other suitable material.

The separator 130 is interposed between the positive electrode 110 and the negative electrode 120 to insulate the positive electrode 110 and the negative electrode 120 from one another.

The separator 130, according to one embodiment, is formed of a non-woven fabric.

The separator 130, in one embodiment, includes polyethylene, polypropylene, polyvinylidene fluoride, polyethylene oxide, polyacrylonitrile, and/or polyvinylidene fluoride hexafluoropropylene. Alternatively, the separator 130 may be formed of any other suitable material or combination of materials.

In one embodiment, as illustrated in FIG. 2, the separator 130 is interposed between the positive electrode 110 and the negative electrode 120, and further covers and insulates the outermost portion of the electrode assembly 100, specifically, the positive electrode 110 or the negative electrode 120 that is disposed at the outermost portion of the electrode assembly 100. According to the above-described embodiment, the separator 130 is configured to insulate the positive electrode 110 and the negative electrode 120, and also insulate the electrode assembly 100 and other devices.

The electrode assembly 100, in one embodiment, is a stack type electrode assembly in which the positive electrode 110, the separator 130, and the negative electrode 120, as shown in FIG. 3, are repeatedly stacked. Although not shown in FIG. 3, in one embodiment, as illustrated in FIG. 2, the separator 130 is stacked at the upper portion of the positive electrode 110 or the lower portion of the negative electrode 120 and thereby insulates the negative electrode 120 or the positive electrode 110 that is stacked at the upper portion of the positive electrode 110 or the lower portion of the negative electrode 120.

Among the positive electrode coating portion 112 formed on one of the surfaces (e.g., the second surface 118) of the positive electrode collector of the positive electrode 110 and the negative electrode coating portion 122 formed on one of the surfaces (e.g., the first surface 126) of the negative electrode collector of the negative electrode 120 that is facing the one surface (e.g., the second surface 118) of the positive electrode 110, the positive electrode coating portion 112 and the negative electrode coating portion 122 on the surfaces facing each other have the same area, or the area of the positive electrode coating portion 112 is greater than that of the negative electrode coating portion 122 within a tolerance range. In one embodiment, the tolerance range is about 0.3% of the area of the positive electrode coating portion 112.

In the positive electrode 110 according to one embodiment, the positive electrode coating portion 112 is coated on the first surface 116 or the second surface 118 of the positive electrode collector. In another embodiment, the positive electrode coating portion is coated on both the first surface 116 and the second surface 118. Similarly, in one embodiment, the negative electrode coating portion 122 is coated on the first surface 126 or the second surface 128 of the negative electrode collector of the negative electrode 120. However, in another embodiment, the negative electrode coating portion is coated on both the first surface 126 and the second surface 128.

In one embodiment, as shown in FIG. 3, the positive electrode 110, the separator 130 and the negative electrode 120 are stacked in the order of positive electrode 110/separator 130/negative electrode 120. Further, as shown in FIG. 2, in one embodiment, the order of stacking is separator 130/positive electrode 110/separator 130/negative electrode 120/separator 130.

In the positive electrode 110, in one embodiment, the positive electrode coating portion 112 is coated at all regions of the positive electrode collector other than a positive electrode tab 114. In the negative electrode 120, in one embodiment, the negative electrode coating portion 122 is coated at all regions of the negative electrode collector other than a negative electrode tab 124. In one embodiment, the areas of the positive electrode 110 and the negative electrode 120 of the electrode assembly 100 are the same (e.g., the positive electrode collector and the negative electrode collector have the same size), or the area of the positive electrode 110 may be greater than that of the negative electrode 120 within a tolerance range. In one embodiment, the tolerance range is about 0.3% of the area of the positive electrode 110.

In the positive assembly 100 according to one embodiment, the size of the positive electrode 110 is the same or substantially the same as that of the negative electrode 120, as shown in FIG. 3, and as a result, the positive electrode 110 and the negative electrode 120 can easily be aligned. The alignability of the positive electrode 110 and negative electrode 120 prevents or reduces structural unstability and chemical unstability from occurring due to the alignment error of the positive electrode 110 and the negative electrode 120.

According to another embodiment, the size of the positive electrode 110 may be different from that of the negative electrode 120. However, as described above, the positive electrode coating portion 112 coated on the positive electrode collector of the positive electrode 110 and the negative electrode coating portion 122 coated on the negative electrode collector of the negative electrode 120 have the same area, or the area of the positive electrode coating portion 112 is greater than that of the negative electrode coating portion 122 within a tolerance range. That is, the positive electrode collector of the positive electrode 110 and the negative electrode collector of the negative electrode 120 may have sizes different from one another, but the area of the positive electrode coating portion 112 formed on any one surface of the positive electrode collector is the same as that of the negative electrode coating portion 122 formed on any one surface of the negative electrode collector (e.g., a surface of the negative electrode collector that is facing the surface of the positive electrode collector), or the area of the positive electrode coating portion 112 should be greater than that of the negative electrode coating portion 122 within a tolerance range.

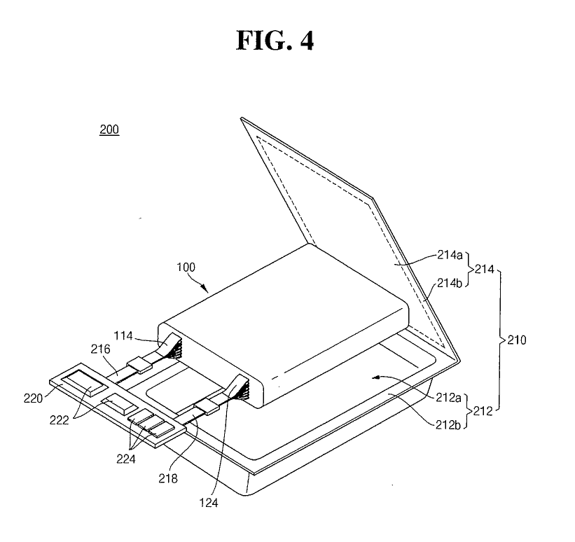

FIG. 4 illustrates a secondary battery including an electrode assembly according to another exemplary embodiment of the present invention.

Referring to FIG. 4, a secondary battery 200 including an electrode assembly according to an exemplary embodiment includes the electrode assembly 100 that has been described above with reference to FIGS. 1 through 3, an external case 210, and a circuit protection module 220.

The external case 210, according to one embodiment, includes a body 212 and a cover 214.

The body 212, in one embodiment, includes an accommodation part 212a being a space for receiving, or accommodating, the electrode assembly 100, and a sealing part 212b extending outward from an opening region of the accommodation part 212a.

The cover 214, in one embodiment, extends from an edge of the sealing part 212b of the body 212 and may be rotatably, or hinged, open and closed about the edge of the sealing part 212b to contain the electrode assembly 100 in the external case 210.

The cover 214, in one embodiment, includes a cover region 214a corresponding to the accommodation part 212a of the body 212 and a sealing part 214b corresponding to the sealing part 212b of the body 212. The cover region 214a of the cover 214 covers the accommodation part 212a of the body 212, and the sealing part 214b of the cover 214 is sealed with the sealing part 212b of the body 212.

In the secondary battery 200 according to one embodiment, the electrode assembly 100 is received, or accommodated, in the accommodation part 212a, and the sealing part 212b of the body 212 and the sealing part 214b of the cover 214 are sealed, such as through a thermal bonding scheme.

The secondary battery 200, in one embodiment, includes a positive electrode lead 216 that is extended from the positive electrode tabs 114 of the electrode assembly 100, the positive electrode tabs 114 of the stacked positive electrodes 110 being connected together, and a negative electrode lead 218 that is extended from the negative electrode tabs 124 of the electrode assembly 100, the negative electrode tabs 124 of the stacked negative electrodes 120 being connected together.

The circuit protection module 220, in one embodiment, is electrically connected to the electrode assembly 100 through the positive electrode lead 216 and the negative electrode lead 218.

The circuit protection module 220, in one embodiment, includes control devices 222 configured to control the secondary battery 100.

The circuit protection module 220, in one embodiment, is configured to control the charge/discharge of the secondary battery 100.

The circuit protection module 220, in one embodiment, includes external terminals 224 configured to connect the secondary battery 100 to external equipment or devices.

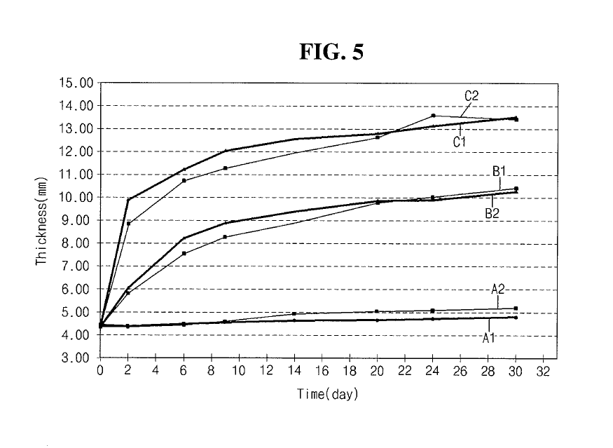

FIG. 5 illustrates a graph showing that swelling does not highly occur in the secondary battery including the electrode assembly according to an exemplary embodiment.

The graph of FIG. 5 shows results of swelling tests measuring thickness of secondary batteries over time. The results shown in FIG. 5 correspond to swelling tests performed on two secondary batteries 200 (which are indicated by A1 and A2 in the graph of FIG. 5) including the electrode assembly 100; swelling tests performed on two secondary batteries (which are indicated by B1 and B2 in the graph of FIG. 5) including an electrode assembly in which the area ratio of a positive electrode coating portion to a negative electrode coating portion is 1.05 (i.e. the area of the positive electrode coating portion is greater than the area of the negative electrode coating portion by an amount greater than the tolerance range described above with respect to the electrode assembly 100); and swelling tests performed on two secondary batteries (which are indicated by C1 and C2 in the graph of FIG. 5) in which the area ratio of a negative electrode coating portion to a positive electrode coating portion is 1.05 and the area of the negative electrode coating portion is greater than that of the positive electrode coating portion.

The swelling test, for which results are shown in FIG. 5, is a test that charges/discharges the secondary battery at a temperature of 55° C. to measure a thickness change of the secondary battery over time. FIG. 5 shows the thickness of the secondary batteries over time and, more specifically, shows the thickness changing from an initial thickness of about 4.5 mm from 0 to 30 days.

Referring to FIG. 5, in the secondary battery 200 including the electrode assembly 100 according to an embodiment of the present invention, it can be seen that swelling does not highly occur.

That is, as shown in the graph of FIG. 5, in the secondary batteries 200 including the electrode assembly 100 according to an embodiment of the present invention, it can be seen that the thickness does not change substantially even when the swelling test is performed over a long period of time, as shown through data of reference numerals A1 and A2.

On the other hand, in secondary batteries in which the area ratio of the positive electrode coating portion and the negative electrode coating portion that are facing each other is 1.05 and the area of the positive electrode coating portion is greater than the area of the negative electrode coating portion by an amount greater than the tolerance range described above with respect to the electrode assembly 100, it can be seen from FIG. 5 that the change of thickness is large, as shown through data of reference numerals B1 and B2. Moreover, in secondary batteries in which the area ratio of the negative electrode coating portion and the positive electrode coating portion that are facing each other is 1.05 and the area of the negative electrode coating portion is greater than that of the positive electrode coating portion, it can also be seen from FIG. 5 that the change of thickness is large, as shown through data of reference numerals C1 and C2.

Accordingly, in the secondary battery 200 including the electrode assembly 100 according to an embodiment of the present invention, the graph of FIG. 5 illustrates that an amount of swelling is small.

According to exemplary embodiments of the present invention, the area of the positive electrode coating portion is the same as that of the negative electrode coating portion, or the area of the positive electrode coating portion is greater than that of the negative electrode coating portion within a tolerance range.

According to exemplary embodiments of the present invention, moreover, structural unstability and chemical unstability due to an alignment error are reduced or prevented because the positive electrode and the negative electrode are easily aligned.

Some exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An electrode assembly comprising:
a positive electrode comprising a positive electrode coating portion coated on a surface of a positive electrode collector;
a negative electrode comprising a negative electrode coating portion coated on a surface of a negative electrode collector; and
a separator between the positive electrode and the negative electrode for insulating the positive electrode and the negative electrode,
wherein:
the positive electrode and the negative electrode are stacked, and the surface of the positive electrode and the surface of the negative electrode are facing each other, and
the positive electrode coating portion and the negative electrode coating portion on the surfaces facing each other have a same area, or an area of the positive electrode coating portion is greater than an area of the negative electrode coating portion within a first tolerance range.

2. The electrode assembly as claimed in claim 1, wherein the first tolerance range is about 0.3% of the area of the positive electrode coating portion.

3. The electrode assembly as claimed in claim 1, wherein an area of the positive electrode is the same as an area of the negative electrode, or the area of the positive electrode is greater than the area of the negative electrode within a second tolerance range.

4. The electrode assembly as claimed in claim 3, wherein the second tolerance range is about 0.3% of the area of the positive electrode.

5. The electrode assembly as claimed in claim 1, wherein the separator comprises a non-woven fabric.

6. The electrode assembly as claimed in claim 5, wherein the separator comprises a material selected from the group consisting of polyethylene, polypropylene, polyvinylidene fluoride, polyethylene oxide, polyacrylonitrile, and polyvinylidene fluoride hexafluoropropylene.

7. The electrode assembly as claimed in claim 1, wherein the negative electrode coating portion comprises lithium titanium oxide (LTO).

8. The electrode assembly as claimed in claim 1, wherein the positive electrode coating portion is coated on an entire area of the surface of the positive electrode other than a positive electrode tab, and the negative electrode coating portion is coated on an entire area of the surface of the negative electrode other than a negative electrode tab.

9. The electrode assembly as claimed in claim 1, wherein the positive electrode coating portion is further coated on another surface of the positive electrode that is opposite the surface of the positive electrode, and the negative electrode coating portion is further coated on another surface of the negative electrode that is opposite the surface of the negative electrode.

10. A secondary battery comprising:
an electrode assembly;
a pouch accommodating the electrode assembly; and
a circuit protection module electrically connected to the electrode assembly,
wherein:
the electrode assembly comprises:
a positive electrode comprising a positive electrode coating portion coated on a surface of a positive electrode collector;
a negative electrode comprising a negative electrode coating portion coated on a surface of a negative electrode collector; and
a separator between the positive electrode and the negative electrode for insulating the positive electrode and the negative electrode, and
the positive electrode and the negative electrode are stacked, and the surface of the positive electrode and the surface of the negative electrode are facing each other, and
the positive electrode coating portion and the negative electrode coating portion on the surfaces facing each other have a same area, or an area of the positive electrode coating portion is greater than an area of the negative electrode coating portion within a first tolerance range.

11. The secondary battery as claimed in claim 10, wherein the first tolerance range is about 0.3% of the area of the positive electrode coating portion.

12. The secondary battery as claimed in claim 10, wherein an area of the positive electrode is the same as an area of the negative electrode, or the area of the positive electrode is greater than the area of the negative electrode within a second tolerance range.

13. The secondary battery as claimed in claim 12, wherein the second tolerance range is about 0.3% of the area of the positive electrode.

14. The secondary battery as claimed in claim 10, wherein the separator comprises a non-woven fabric.

15. The secondary battery as claimed in claim 14, wherein the separator comprises a material selected from the group consisting of polyethylene, polypropylene, polyvinylidene fluoride, polyethylene oxide, polyacrylonitrile, and polyvinylidene fluoride hexafluoropropylene.

16. The secondary battery as claimed in claim 10, wherein the negative electrode coating portion comprises lithium titanium oxide (LTO).

17. The secondary battery as claimed in claim 10, wherein the electrode assembly is a stack type electrode assembly.

18. The secondary battery as claimed in claim 10, wherein the positive electrode coating portion is coated on an entire area of the surface of the positive electrode other than a positive electrode tab, and the negative electrode coating portion is coated on an entire area of the surface of the negative electrode other than a negative electrode tab.
